(19) United States
(12) Patent Application Publication
(10) Pub. No.: US 2024/0048496 A1
(43) Pub. Date: Feb. 8, 2024

(54) APPARATUS AND METHOD FOR THE INTRINSIC ANALYSIS OF THE CONNECTION QUALITY IN RADIO NETWORKS HAVING NETWORK-CODED COOPERATION

(71) Applicant: Fraunhofer-Gesellschaft zur Förderung der angewandten Forschung e.V., München (DE)

(72) Inventors: Andreas FROTZSCHER, Dresden (DE); Hannes ELLINGER, Dresden (DE); Oliver HAALA, Erlangen (DE); Jürgen HUPP, Erlangen (DE); Frank BURKHARDT, Erlangen (DE); Kirsten SCHUH, Erlangen (DE)

(21) Appl. No.: 18/490,862

(22) Filed: Oct. 20, 2023

Related U.S. Application Data
(63) Continuation of application No. PCT/EP2022/060591, filed on Apr. 21, 2022.

(30) Foreign Application Priority Data
Apr. 23, 2021 (EP) 21170130.5

(51) Int. Cl. H04L 47/2491; H04L 69/22

(52) U.S. Cl. CPC H04L 47/2491; H04L 69/22

(57) ABSTRACT

An apparatus determines a transmission quality in a communications network. A first network unit of the communications network is configured to perform a first data transmission, in that first data, to be sent from the first network unit, are transmitted in such a way that a first data packet depends on the first data. A second network unit of the communications network is configured to perform a second data transmission, in that second data, to be sent from the second network unit, are transmitted in such a way that the second data are combined with the first data in a second data packet. The apparatus has a receiving unit configured to receive the second data transmission. Furthermore, an evaluation unit is configured to determine a first quality of the first data transmission or a second quality of the second data transmission, wherein the evaluation unit evaluates the second data packet.

### CROSS-REFERENCE TO RELATED APPLICATIONS

This application is a continuation of copending International Application No. PCT/EP2022/060591, filed Apr. 21, 2022, which is incorporated herein by reference in its entirety, and additionally claims priority from European Application No. 21170130.5, filed Apr. 23, 2021, which is also incorporated herein by reference in its entirety.

### TECHNICAL FIELD

The application relates to an apparatus and a method for the intrinsic analysis of the connection quality in radio networks having network-coded cooperation.

### BACKGROUND OF THE INVENTION

Radio systems, in particular in industrial applications having fast reaction times or high demands on security and availability, are subject to high demands with respect to packet loss rate, data rate, or transmission latency in bi-directional transmission. Examples in which data are intended to be transmitted over a radio system in a manner having fast reaction times and a high degree of security are, for example, data from sensors or actuators in mobile scenarios or, for example, data from (motor) controllers.

In order to achieve deterministic time behavior in radio transmission, typically scheduling methods or time division multiple access (TDMA) are used. In the event of error-free transmission, this leads to a deterministic transmission latency or cycle time of the radio system. In the event of a disruption of the transmission, measures are taken. However, these measures must not adversely affect the time requirements for the transmission since external control systems otherwise react to the transmission disruption, for example, by emergency operation or by deactivating the machine.

The measures for increasing the robustness typically take place in different ways, for example by adapting the modulation method used, or by adapting the channel coding for improving the individual connection (link), or by a retransmission or ARQ/HARQ methods having a packet repetition within the cycle time, or by antenna diversity for making use of a plurality of transmission paths, in the case of multipath propagation.

A further measure for increasing the robustness is that of relaying and cooperative methods (cooperative communication CC), wherein forwarding of packets by another radio node as forwarding intermediate nodes 211, 212, 219 takes place (see FIG. 2). Path redundancy results over these intermediate nodes 211, 212, 219 too. In this respect, FIG. 2 shows an example of cooperative communication (source: A Tutorial on Network Coding).

Network-coded cooperation also represents a measure for increasing the robustness. In this case, the forwarded messages in the relay nodes are combined with one another by network coding methods, and the combined messages are transmitted (see FIG. 3). For instance, FIG. 3 shows an example of network-coded cooperation (source: A Tutorial on Network Coding) using network-coded symbols 321, 322, 323.

If the possibilities on a link are exhausted by channel coding, CC and in particular NCC offer great potential, since what is known as the diversity order (number of propagation paths) of the overall system is increased. In this case, which nodes are intended to combine (encode) and send on which packets is decisive.

This can be specified either in a pseudo-random manner (random linear coding) or in a deterministic manner. In both cases, it is advantageous to know the state of the connections (link quality) between the nodes, in order to adapt the coding to the network state. For this purpose, an analysis of the connection quality (link analysis) is carried out. In the following, the term “link analysis” is also used synonymously.

Knowledge of the connection quality in the network is important in particular when the transmissions in the network have to be very reliable, i.e. may have only an extremely low transmission error rate, and at the same time the transmission latencies must be very low.

In the known technology, in order to analyze the state of the different links in a radio network, either additional test packets are transmitted, or the transmitted data or management packets are used. Based on the received packets, the receiving radio nodes can analyze the connection quality to the transmitting radio nodes. For this purpose, usually statistical analyses of various technical parameters such as reception performance, bit error rate (BER), packet error rate (PER), signal-to-noise ratio (SNR or SINR), and metrics from the channel impulse response are performed. The results of the statistical analyses are usually post-processed by means of aggregation, compression, quantization, or mapping onto a metric. The result is then transmitted to the network management, either in a results-controlled manner or at regular intervals, either as a separate packet or as part of a packet to be transmitted. In each case, additional transmission resources are used for transmitting the metrics of the connection quality, which resources are no longer available for a payload transmission.

WO 2014 159616 A2 discloses a protocol for network coding, in which what are known as helper nodes use random linear network coding methods in order to support the data communication between different radio nodes. The configuration of the network coding and the transmission timepoint of the packets encoded thereby, via the helper nodes, is selected on the basis of information relating to the state of the link quality of the various links in the network. This means that the information relating to the connection states must be known to the network management. However, WO 2014 159616 A3 does not describe any methods for raising the connection quality in the network.

In U.S. Pat. No. 8,842,599 B2, relay nodes are used for data transmission in downlink and uplink between a base station and user terminals. The relay nodes analyze the communication traffic which they forward between the base station and the user terminals, calculate from this information relating to the connection quality, and send on this information to the base station. The base station processes this information and selects, on the basis thereof, a relay node per group of user terminals, in order to apply network coding methods to the data traffic to or from this group of user terminals.

US 2014 0222996 A1 discloses a use of distributed monitoring in a network. Various performance parameters and metrics are acquired at a plurality of points in the network, which parameters and metrics reflect the current state of the connections or of the message flow in the network. The monitoring units transmit their analysis results to the network management. Said performance parameters and/or metrics are analyzed with respect to their relevance in the current network state. The network management is informed of which performance parameters and metrics are currently relevant, and in turn informs all the monitoring units, distributed in the network, to analyze only the selected performance parameters. The aim is to reduce the data traffic of the monitoring units for network management, by selecting the performance parameters to be analyzed.

US 2014 0036696 A1 describes that, in a network, the mobile terminals perform a link analysis of their connections and forward the analysis results to a network controller. On the basis of this information, the network controller sends a recommendation to the terminals with regard to whether they should use the cellular network or the access point of an available WLAN network.

### SUMMARY

An embodiment may have an apparatus for determining a transmission quality in a communications network, wherein a first network unit of the communications network is configured to perform a first data transmission, in that first data, to be sent from the first network unit, are transmitted in such a way that a first data packet depends on the first data, wherein a second network unit of the communications network is configured to perform a second data transmission, in that second data, to be sent from the second network unit, are transmitted in such a way that the second data are combined with the first data in a second data packet, wherein the apparatus has a receiving unit configured to receive the second data transmission, and wherein the apparatus has an evaluation unit configured to determine a first quality of the first data transmission and/or a second quality of the second data transmission, in that the evaluation unit evaluates the second data packet.

According to another embodiment, a communications network may have: a first network unit, a second network unit, and an inventive apparatus as mentioned above for determining a transmission quality in a communications network, wherein the first network unit is configured to perform a first data transmission, in that first data, to be sent from the first network unit, are transmitted in such a way that a first data packet depends on the first data, wherein a second network unit is configured to perform a second data transmission, in that second data, to be sent from the second network unit, are transmitted in such a way that the second data are combined with the first data in a second data packet, wherein the receiving unit of the apparatus is configured to receive the second data transmission, and wherein the evaluation unit of the apparatus is configured to determine the first quality of the first data transmission and/or the second quality of the second data transmission, in that the evaluation unit evaluates the second data packet.

According to another embodiment, a method for determining a transmission quality in a communications network may have the steps of: performing a first data transmission by a first network unit of the communications network, in that first data, to be sent from the first network unit, are transmitted in such a way that a first data packet depends on the first data, performing a second data transmission by a second network unit of the communications network, in that second data, to be sent from the second network unit, are transmitted in such a way that the second data are combined with the first data in a second data packet, receiving the second data transmission by a receiving unit of an apparatus, and determining a first quality of the first data transmission and/or a second quality of the second data transmission by an evaluation unit of the apparatus, in that the evaluation unit evaluates the second data packet.

Another embodiment may have a non-transitory computer-readable medium having a computer program for implementing the method for determining a transmission quality in a communications network as mentioned above, when the method is implemented by a computer or signal processor.

An apparatus for determining a transmission quality in a communications network is provided. A first network unit of the communications network is configured to perform a first data transmission, in that first data, to be sent from the first network unit, are transmitted in such a way that a first data packet depends on the first data. A second network unit of the communications network is configured to perform a second data transmission, in that second data, to be sent from the second network unit, are transmitted in such a way that the second data are combined with the first data in a second data packet. The apparatus comprises a receiving unit which is configured to receive the second data transmission. Furthermore, the apparatus comprises an evaluation unit configured to determine a first quality of the first data transmission and/or a second quality of the second data transmission, in that the evaluation unit evaluates the second data packet.

Furthermore, a method for determining a transmission quality in a communications network is provided. A first network unit of the communications network performs a first data transmission, in that first data, to be sent from the first network unit, are transmitted in such a way that a first data packet depends on the first data. A second network unit of the communications network performs a second data transmission, in that second data, to be sent from the second network unit, are transmitted in such a way that the second data are combined with the first data in a second data packet. The apparatus comprises a receiving unit which receives the second data transmission. Furthermore, the apparatus comprises an evaluation unit which determines a first quality of the first data transmission and/or a second quality of the second data transmission, in that the evaluation unit evaluates the second data packet.

Furthermore, a computer program having a program code for carrying out the method according to an embodiment is provided.

According to embodiments, concepts are provided by means of which a specific radio node (e.g. the base station) can receive knowledge of the transmission quality of connections in which it is not directly involved, i.e. is neither the transmitting node nor the receiving node, and of connections in which it is directly involved. This knowledge is obtained only from the analysis of payload of received radio packets.

In embodiments, it is not necessary neither for additional radio packets to be transmitted, nor for a portion of the payload in the packets to be sacrificed for transmission information on the connection quality. Thus, there is no need for any additional network traffic for transmitting the connection metrics.

### BRIEF DESCRIPTION OF THE DRAWINGS

Embodiments of the invention will be described below, making reference to the drawings, in which:

FIG. 1 shows an apparatus according to an embodiment, in a communications network which further comprises a first network unit, a second network unit, and optionally a further, third network unit;

FIG. 2 shows an example of cooperative communication;

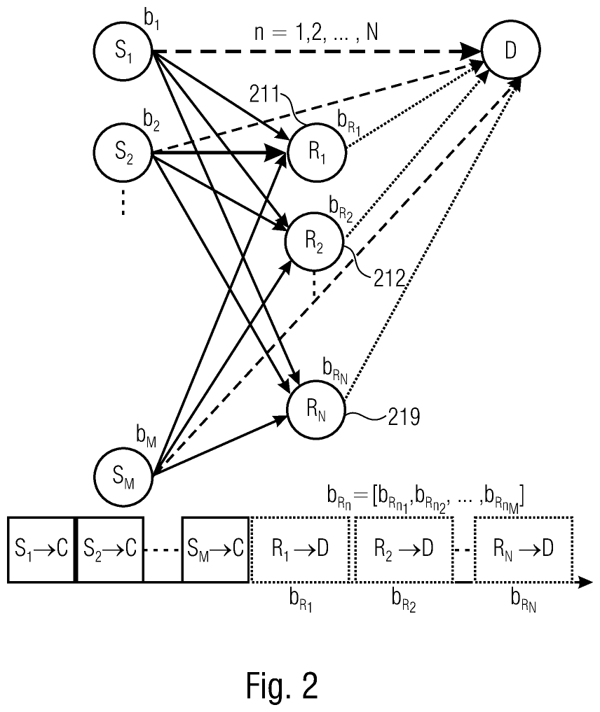

FIG. 3 shows an example of network-coded cooperation;

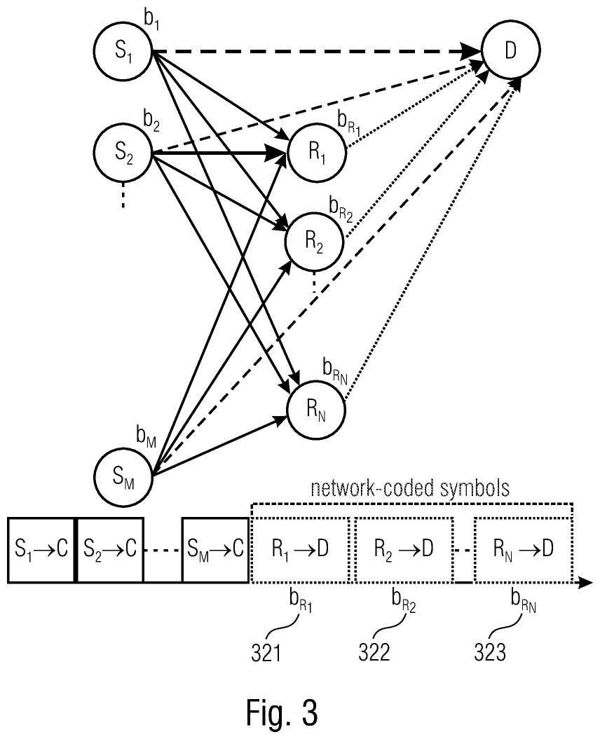

FIG. 4 shows an example of a fully meshed radio network, in which the base station has a connection to all the radio nodes, and the radio nodes are also connected to one another;

FIG. 5 shows a calculation, by way of example, of a coded packet on the basis of two source packets;

FIG. 6 shows an example of a coded packet having a complete header;

FIG. 7 shows a superframe structure, by way of example, having network-coded cooperation;

FIG. 8 shows a topology of a network comprising a base station and three radio nodes; and

FIG. 9 shows an example of a possible superframe structure having network-coded cooperation, wherein the network comprises a base station and three radio nodes.

### DETAILED DESCRIPTION OF THE INVENTION

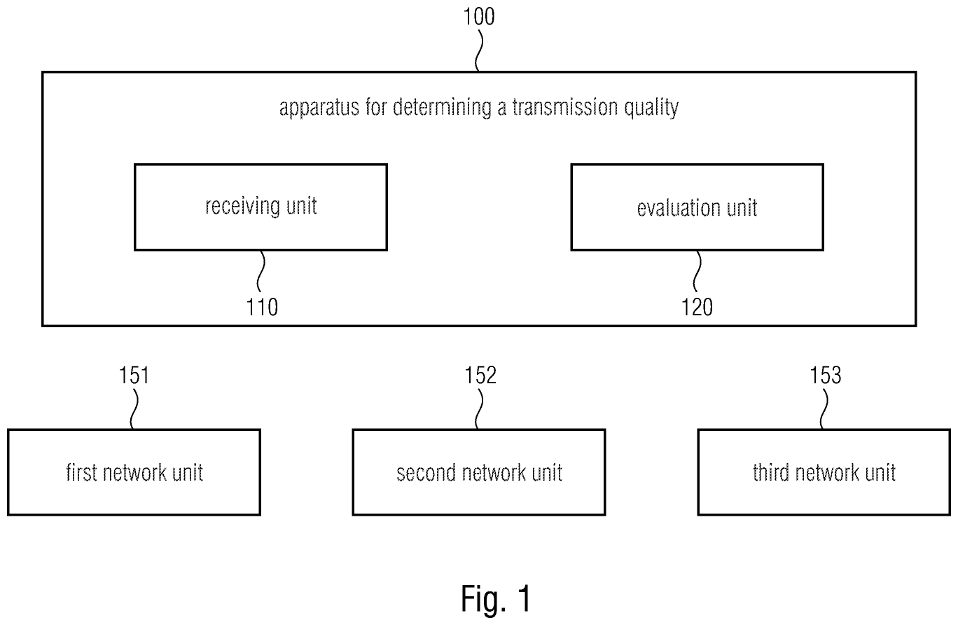

FIG. 1 shows an apparatus 100 according to an embodiment, in a communications network which further comprises a first network unit 151, a second network unit 152, and optionally a further, third network unit 153.

The apparatus 100 is an apparatus 100 for determining a transmission quality in a communications network.

A first network unit 151 of the communications network is configured to perform a first data transmission, in that first data, to be sent from the first network unit 151, are transmitted in such a way that a first data packet depends on the first data.

A second network unit 152 of the communications network is configured to perform a second data transmission, in that second data, to be sent from the second network unit 152, are transmitted in such a way that the second data are combined with the first data in a second data packet.

The apparatus 100 comprises a receiving unit 110 which is configured to receive the second data transmission.

Furthermore, the apparatus 100 comprises an evaluation unit 120 configured to determine a first quality of the first data transmission and/or a second quality of the second data transmission, in that the evaluation unit 120 evaluates the second data packet.

According to an embodiment, the evaluation unit 120 can, for example, be configured to determine whether the first data transmission from the first network unit 151 to the second network unit 152 has taken place successfully, in that the evaluation unit 120 evaluates a header of the second data packet.

In an embodiment, the evaluation unit 120 can, for example, be configured to evaluate the header of the second data packet with respect to whether the header of the second data packet comprises coding information for decoding the first data of the second data packet.

According to an embodiment, the evaluation unit 120 can, for example, be configured to evaluate the header of the second data packet with respect to whether the header of the second data packet comprises a coding coefficient which the second network unit 151 has used for coding the first data in the second data packet.

In an embodiment, the receiving unit 110 can, for example, be configured to receive the first data transmission and the second data transmission, In this case, the evaluation unit 120 can, for example, be configured to determine a first quality of the first data transmission and/or a second quality of the second data transmission, in that the evaluation unit 120 evaluates the first data packet and the second data packet.

According to an embodiment, the evaluation unit 120 of the apparatus 100 can, for example, be configured to determine the first data from the first data packet as first identified data. In this case, the evaluation unit 120 of the apparatus 100 can, for example, be configured to determine, using the first identified data, whether the second data packet was formed using the first data. The evaluation unit 120 of the apparatus 100 can, for example, be configured to determine that the first data transmission from the first network unit 151 to the second network unit 152 has taken place successfully, when the second data packet was formed using the first data. Furthermore, the evaluation unit 120 of the apparatus 100 can, for example, be configured to determine that the first data transmission from the first network unit 151 to the second network unit 152 has not taken place successfully, when the second data packet was not formed using the first data.

In an embodiment, a third network unit 153 of the communications network can, for example, be configured to perform a third data transmission, in that third data, to be sent from the third network unit 153, are transmitted in such a way that the third data are combined with the first data and with the second data in a third data packet. In this case, the evaluation unit 120 of the apparatus 100 can, for example, be configured to determine the first data from the first data packet as first identified data. The evaluation unit 120 of the apparatus 100 can, for example, be configured to determine the second data from the second data packet as second identified data. Furthermore, the evaluation unit 120 of the apparatus 100 can, for example, be configured to determine, using the first identified data and using the second identified data, whether the third data packet was formed using the first data and using the second data. Furthermore, the evaluation unit 120 of the apparatus 100 can, for example, be configured to determine that the first data transmission from the first network unit 151 to the third network unit 153 has taken place successfully, and that the second data transmission from the second network unit 152 to the third network unit 153 has taken place successfully, when the third data packet was formed using the first data and using the second data. In this case, the evaluation unit 120 of the apparatus 100 can, for example, be configured to determine that the first data transmission from the first network unit 151 to the third network unit 153 and/or the second data transmission from the second network unit 152 to the third network unit 153 has not taken place successfully, when the third data packet was not formed using both the first data and the second data.

According to an embodiment, the apparatus 100 can, for example, comprise a sending unit which can, for example, be configured to perform a first further data transmission, in that first further data, to be sent from the sending unit, are transmitted in such a way that the first further data are combined with the first data and with the second data in a first further data packet. The first network unit 151 or the second network unit 152 or a further network unit 153 of the communications network can, for example, be configured to perform a second further data transmission, in that second further data, to be sent, are transmitted in such a way that the second further data are combined with the first further data in a second further data packet. The receiving unit 110 of the apparatus 100 can, for example, be configured to receive the second further data transmission. The evaluation unit 120 of the apparatus 100 can, for example, be configured to determine, using the first further data, whether the second further data packet was formed using the first further data. Furthermore, the evaluation unit 120 of the apparatus 100 can, for example, be configured to determine that the first further data transmission from the apparatus 100 to the first network unit 151 or to the second network unit 152 or to the further network unit 153 has taken place successfully, when the second further data packet was formed using the first further data. Furthermore, the evaluation unit 120 of the apparatus 100 can, for example, be configured to determine that the first further data transmission from apparatus 100 to the first network unit 151 or to the second network unit 152 or to the further network unit 153 has not taken place successfully, when the second further data packet was not formed using the first further data.

In an embodiment, the apparatus 100 can, for example, be configured to keep link statistics for each pair of one transmitting network unit and one receiving network unit from a group of network units of the communications network comprising the first network unit 151 and the second network unit 152, which statistics record each successful data transmission, identified by the apparatus 100, from the transmitting network unit to the receiving network unit, as successful data transmission, and/or record each unsuccessful data transmission, identified by the apparatus 100, from the transmitting network unit to the receiving network unit, as unsuccessful data transmission.

In an embodiment, the second network unit 152 can, for example, be configured to determine information relating to a data transmission quality from the first network unit 151 to the second network unit 152. In this case, the second network unit 152 can, for example, be configured to transmit the information, relating to the data transmission quality from the first network unit 151 to the second network unit 152, to the apparatus 100, in that the second network unit 152 selects a coding rule from a group of two or more coding rules, and codes the first data and/or the second data and/or a combination of the first data and the second data in the second data packet depending on the coding rule, and provides them with a check code. The apparatus 100 can, for example, be configured to identify the information relating to the data transmission quality from the first network unit 151 to the second network unit 152 in that the apparatus 100 determines, using the check code contained in the second data packet, the coding rule of the two or more coding rules that was selected by the second network unit 152. For example, the coding rules from which the second network unit 152 selects can be whether the data to be sent are big endian-coded or little endian-coded. The check code can, for example, be a CRC code or another error-identifying check code, or an error-correcting check code. The apparatus can, for example, determine, by means of the transmitted check code, whether the decoding based on little endian or based on big endian results in a correspondence of the calculated check code and the transmitted check code, i.e. whether the data coded in the second data packet are little endian-coded or big endian-coded.

According to an embodiment, the second network unit 152 can, for example, be configured to perform the second data transmission, in that the second data, to be sent from the second network unit 152, are transmitted in such a way that the second data are combined with the first data, as the second data packet, by superposition.

In an embodiment, the second network unit 152 can, for example, be configured to perform the second data transmission, in that the second data, to be sent from the second network unit 152, are transmitted in such a way that the second data are XOR-linked with the first data in the second data packet, or that the second data are combined with the first data by means of a weighted addition, or that the second data are combined with the first data by a superposition in a Galois field.

According to an embodiment, the second network unit 152 can, for example, be configured to combine the first data, which are combined using a first coding coefficient (e.g. multiplied), with the second data, which are combined using a second coding coefficient (e.g. multiplied), in the second data packet.

In an embodiment, the second network unit 152 can, for example, be configured to XOR-link the first data, which are multiplied by a first coding coefficient, with the second data, which are multiplied by a second coding coefficient, in the second data packet (a XOR link is a superposition in the Galois field F₂^{N}).

According to an embodiment, the communications network can, for example, be a wireless communications network, wherein the first network unit 151 can, for example, be a first wireless network unit, wherein the second network unit 152 can, for example, be a second wireless network unit, and wherein the receiving unit 110 of the apparatus 100 can, for example, be a receiving unit 110 for receiving wireless data transmissions.

Furthermore, in an embodiment, a base station is provided, wherein the base station can comprise the dev apparatus ice 100 described above.

Furthermore, in an embodiment, a communications network is provided. The communications network comprises a first network unit 151, a second network unit 152, and the above-described apparatus 100 for determining a transmission quality in a communications network. In this case, the first network unit 151 can, for example, be configured to perform a first data transmission, in that first data, to be sent from the first network unit 151, are transmitted in such a way that a first data packet depends on the first data. Furthermore, the second network unit 152 can, for example, be configured to perform a second data transmission, in that second data, to be sent from the second network unit 152, are transmitted in such a way that the second data are combined with the first data in a second data packet. The apparatus 100 can furthermore, for example, comprise a receiving unit 110 which can, for example, be configured to receive the second data transmission. Furthermore, the apparatus 100 can, for example, comprise an evaluation unit 120 which can, for example, be configured to determine a first quality of the first data transmission and/or a second quality of the second data transmission, in that the evaluation unit 120 evaluates the second data packet.

According to an embodiment, the communications network can, for example, be a wireless communications network. In this case, the first network unit 151 can, for example, be a first wireless network unit. The second network unit 152 can, for example, be a second wireless network unit. Furthermore, the receiving unit 110 of the apparatus 100 can, for example, be a receiving unit 110 for receiving wireless data transmissions.

Before specific embodiments of the invention will be described in detail, firstly general concepts are explained, on which embodiments of the invention are based.

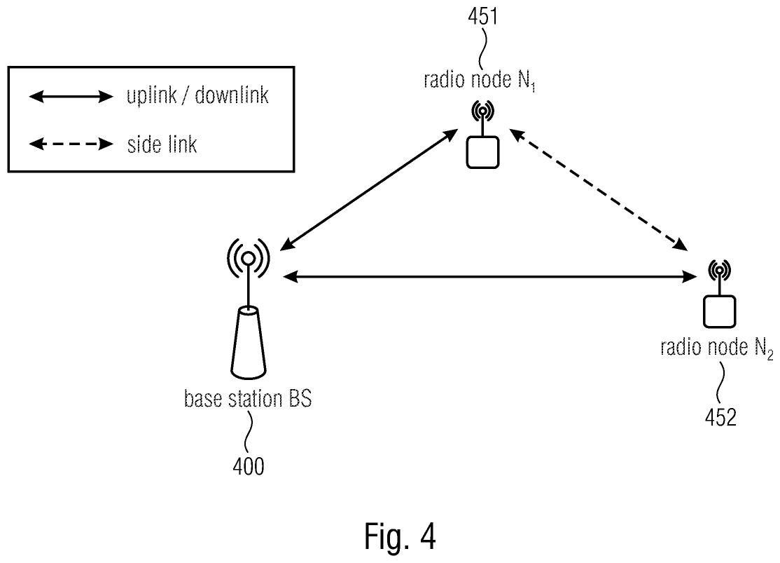

In principle, a network comprises a central base station (BS) and a plurality of radio nodes (Nₓ). In this case, the base station or superordinate instances are responsible for the management of the network, in particular the coordinating of the channel access and the resource management. The network serves for transmission of information between spatially distributed devices. A packet transmission from the BS to a radio node Nₓ is referred to as downlink (DL) transmission, while a transmission from a radio node Nₓ to the BS is referred to as uplink (UL) transmission. A radio node from which payload is intended to be transmitted is referred to as the source node (SN). The radio node to which a packet is transmitted is referred to as the destination node (DN). FIG. 4 shows an example of a fully meshed radio network, in which the base station 400 has a connection (uplink or downlink) to all the radio nodes 451, 452, and the radio nodes 451, 452 are also connected to one another (side links).

For the present invention, a radio system is considered in which the channel access is controlled by a central resource management. The resource management is part of the network management and is typically contained in the base station or in a superordinate system. The decisions of the resource management are distributed to the radio nodes via special messages. In this case the modulation method used on the bit transmission layer (physical layer) allows a resource division over time (Time Division Multiple Access, TDMA) or a combination of a time and frequency division, as is implemented, for example, in OFDMA (Orthogonal Frequency Division Multiple Access) or Single Carrier-Frequency Division Multiple Access (SC-FDMA). In this case, the resources can be assigned to the individual transmissions in a time/frequency grid. Depending on the access method used, the resource management operates on the basis of time slots or time/frequency blocks. These units are referred to synonymously in the following as resources or resource blocks. Temporally successive time/frequency blocks can also be considered time slots.

The radio system considered performs isochronous cyclical communication, divided into frames of equal sizes (superframes). In each superframe, real time-critical process data of the application are transmitted (IRT transmission).

In the following, network-coded cooperation (NCC) will be described.

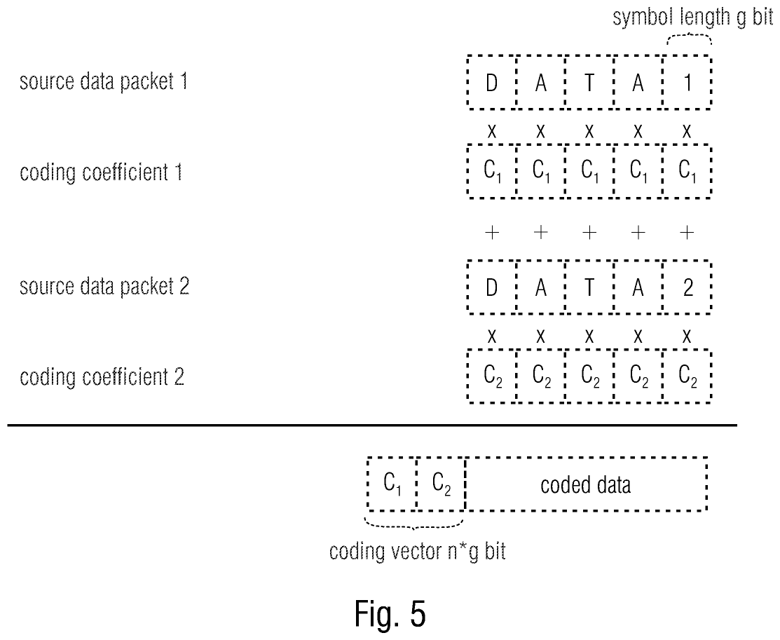

NCC describes a concept in which data packets are combined, prior to forwarding, by a router, in a coded manner, and are sent as superposition. In this case, a plurality of data packets (number n) are in each case weighted and added using coefficients (known as coding coefficients). For this purpose, the algebra is implemented in endless fields, and multiplication/addition in Galois fields having a size/symbol length of g bit is used. For instance, FIG. 5 shows a calculation, by way of example, of a coded packet on the basis of two source packets.

In order that a receiver can decode the packet, information relating to the packets involved and their respective coding coefficients must be known. These coding coefficients are usually combined to what is known as a coding vector.

The data quantity g of a coding coefficient in bits is dependent on the used size/dimension of the Galois field. For Galois fields having characteristic 2, 2^{g} coding coefficients thus result. For the minimum data quantity of g=1, a coding coefficient can assume the values 0 or 1.

If it is not known what data packets are contained and which radio nodes these are intended to be transmitted between, additional header information is also transmitted. This includes two logical addresses per source packet, which addresses specify the data source and the data sink, as well as a coding coefficient, wherein a logical address can be described by what is known as a node identity (node ID/NID). For this purpose, each radio node has a unique NID.

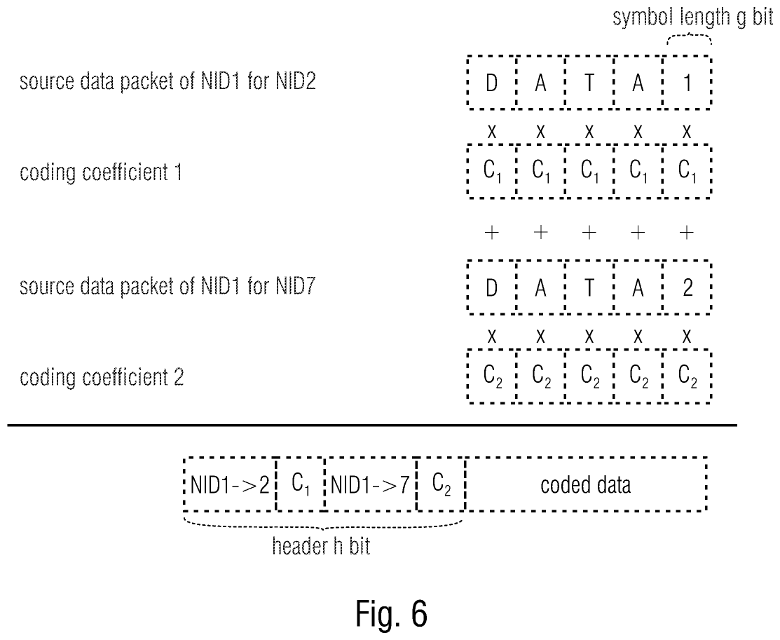

FIG. 6 shows an example of coded packet having a complete header.

Specific embodiments of the invention are described in the following.

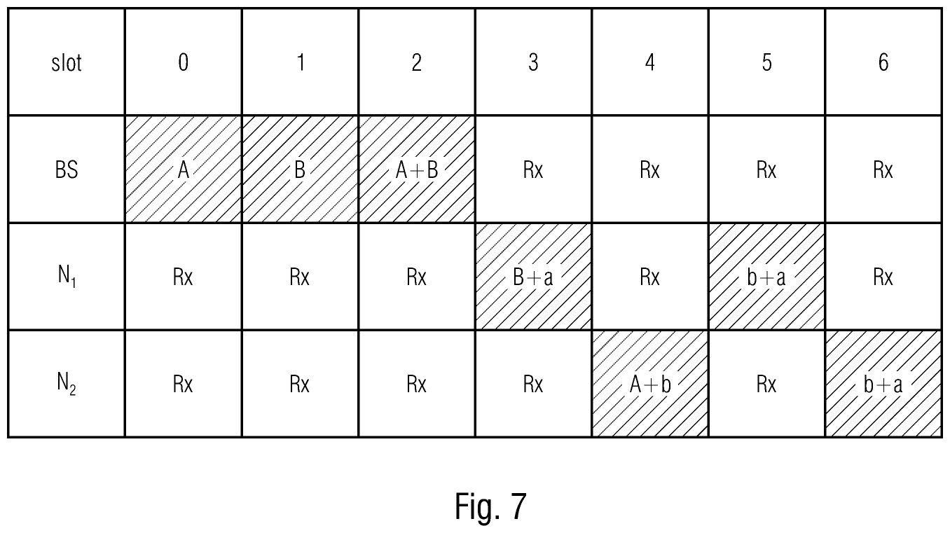

FIG. 7 shows a superframe structure, by way of example, having network-coded cooperation (NCC) for a network as shown in FIG. 4 (the transmitted node is marked green, the received nodes are denoted Rx). The superframe is composed of 7 slots. In this case, the messages “A” and “B” denote the payload which the base station wishes to transmit to N₁ and N₂, respectively. In this case, the messages “a” and “b” denote the payload which N₁ and N₂, respectively, have to transmit to the base station. For example, in slot 0 the BS sends out the message “A”. The radio nodes N₁ and N₂ attempt to receive the packet (Rx). In slot 2 the BS sends out the combined message “A”+“B” via NCC. The following slots are used, as is shown in FIG. 7. The superframe repeats regularly, and can also contain further slots.

Embodiments are based on the fact that the radio nodes can conclude the state or the transmission reliability of the various connections in the network only by analysis of the received packets. This applies both for connections in which the respective radio node is actively involved (i.e. is the transmission or receiving node), and for connections in which it is not actively involved.

The method is described in the following on the basis of the example of the evaluation of the packets received by the base station. However, this does not constitute a restriction. The method for evaluating the received packets can also be applied in an equivalent manner to any other nodes in the network.

| Slot | Evaluation of the | Evaluation of the |
|---|---|---|
| ID | packet reception | contents of the received packet |
| 3 | Packet from N₁ | Packet contains “B”: |
| | correctly received | Entry in link statistics |
| | or not correctly | of DL connection BS −> |
| | received | N₁: successful |
| | => Entry in link | transmission in slot 1 |
| | statistics of UL | or slot 0 & 2 |
| | connection N₁−>BS: | Packet does not contain |
| | successful or | “B”: Entry in link |
| | defective | statistics of DL |
| | transmission in | connection BS −> N₁: |
| | slot 3 | defective transmission |
| | | in slot 1 and slot 0 & 2 |
| | | - resembles HARQ methods: |
| | | Evaluation of ACK/NACK |
| | | packets or flags - |
| 4 | equivalent to slot 3 | equivalent to slot 3 |
| 5 | Packet from N₁ | Packet contains “b”: |
| | correctly received | Entry in link statistics |
| | or not correctly | of side link N₂ −> N₁: |
| | received | successful transmission |
| | => Entry in link | in slot 4 |
| | statistics UL | Packet does not contain |
| | connection N₁−>BS: | “b”: If BS could receive |
| | successful or | the UL packet from N₁ in |
| | defective | slot 3 AND the packet in |
| | transmission in | slot 3 contains “B”, |
| | slot 3 | then with overwhelming |
| | | likelihood N₁ has not |
| | | received, in slot 4, the |
| | | packet from N₂. |
| | | => Entry in link |
| | | statistics for side link |
| | | N₂ −> N₁: defective |
| | | transmission in slot 4 |
| 6 | equivalent to slot 5 | equivalent to slot 5 |

In particular by evaluating the contents of the packets received in slot 5 and 6, the base station obtains knowledge of the transmission reliability on the side link N₁->N₂ and vice versa, without being directly involved in this or having to receive these side link packets. Furthermore, it should be emphasized that the base station obtains this information via the side links, without the relevant nodes N₁ and N₂ having to transmit additional monitoring packets or monitoring information to the base station.

It should be noted that the evaluation of the received packets and their content can take place both slot-for-slot during the progression of the superframe, or alternatively can also be evaluated at the end of a superframe.

It should further be noted that the proposed method can be used for any network coding matrices, in particular for higher degrees of cooperation in which more than two messages are transmitted in one NCC-encoded packet.

In the following, a transmission of detailed quality parameters according to embodiments of the invention is set out.

Since the method presented above only consults packet errors for assessing the connection, it has only limited meaningfulness in situations in which packet errors occur only rarely. An improvement is therefore to analyze further parameters for assessing the link quality, which already suggest an impairment of the connection before a packet loss occurs. These can, for example, be parameters, such as a signal-to-noise ratio (SNR), and/or a received signal strength indicator (RSSI), and/or a number of the bit errors corrected by the error protection coding.

For assessing the link quality, either this information can be consulted directly, or variables derived therefrom can be consulted. The selection of the consulted parameters, as well as their processing, is communicated to all entities, for example by a fixed configuration or a transmission at runtime. Processing steps by way of example can, for example, be combining a plurality of parameters to a metric, and/or quantization, and/or thresholding, and/or rectification, and/or compression, and/or a combination thereof.

The link parameters or variables derived therefrom are transmitted through air, i order for them to be useful for the network management. As described above, according to the current known technology, the size of the transmittable payload had to be reduced for transmitting this additional information (by transmitting additional packets, or allocating bit fields in packets to be transmitted).

In order to prevent this reduction of the transmittable payload amount, the following solution methods are proposed in the present invention:

Embodiments can implement, for example, a modification of the coding coefficients. The coding coefficients are changed when a parameter exceeds or falls below a corresponding threshold value. Alternatively, it is possible to make a selection from a predefined quantity of coding coefficients, in order to represent a certain value range of a parameter. For example, the exponent of the bit error rate can be used directly as the coding coefficient.

Embodiments can implement, for example, a manipulation of the packet structure. The link analysis results can be transmitted in compressed or quantized form, in that the NCC message to be sent, or parts, are manipulated in a purposeful manner. Such manipulation leads to the receiver not being able to correctly decode the message, without knowledge of the manipulation. A decoding error of this kind is identified in the receiver by a conventionally used error detection code, such as CRC-8, but cannot be corrected. However, if the number of possible manipulations is limited, the receiver can try out and take back all conceivable manipulations, until the message can be successfully decoded, and the check of the error detection code is successful.

This method is limited by the error-identifying property of the code used. With every additional modification, the likelihood of a non-valid packet being identified as valid increases.

Modifications by way of example are inter alia a change in the byte or bit sequence, and/or a rotation of the entire packet or parts thereof by a specified number of bits, and/or a superposition of the packet with a short data word or individual bits by means of XOR, and/or an inversion of the packet, individual parts thereof, or individual bits, at specific points.

This modification can be applied to the entire transmit packet or, in the case of use of NCC, only to a subpacket.

For example, the method can be applied to the superframe structure shown in FIG. 7. N₁ receives, in slot 4, the packet superposition “A”+“b”, and measures the signal-to-noise ratio in the process. If it is below a previously determined threshold value, N₁ transmits, in slot 5, the packet superposition “b”+“a” in big endian notation. If the signal-to-noise ratio is below the threshold value, N₁ transmits, in slot 5, the packet superposition “b”+“a” in little endian notation.

The receivers interpret the received packet superposition “b”+“a” both as big endian and as little endian, and decode the packets. In one case, the decoding fails, in the other it is successful. Depending on which decoding was successful, the receiver learns whether the transmission in slot 5 had an SNR above or below the previously determined threshold value.

In embodiments of the invention, no direct transmission of the packet error rate or quality parameters, which can be concluded therefrom, takes place. The packet error rate is derived from information obtained from the received packets, by making use of the network coding.

For the transmission of detailed quality parameters of the link analysis of side links, in embodiments, neither does additional storage space need to be reserved in the packet, nor do additional packets have to be transmitted. The information relating to the quality parameters is transmitted by modification of the NCC coding or by manipulation of the structure of the NCC packets.

A first detailed embodiment is set out in the following.

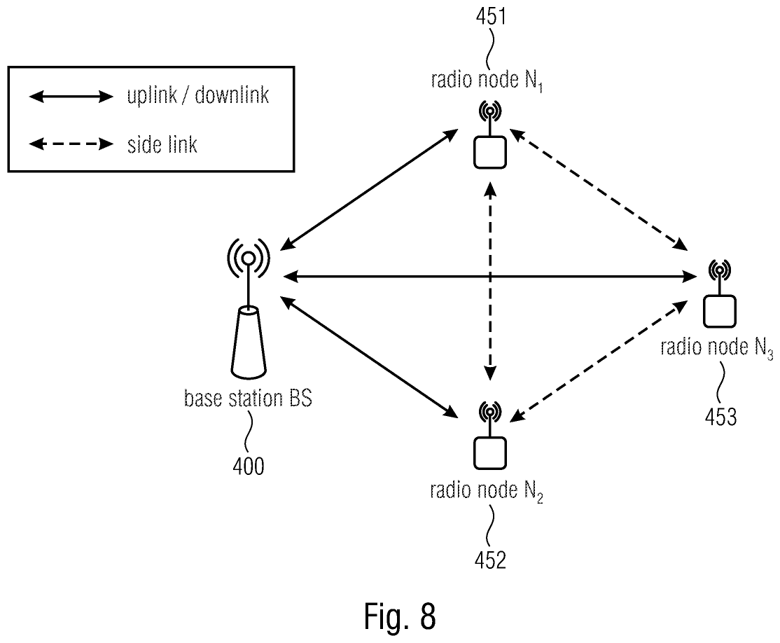

In an embodiment shown in FIG. 8, a topology of a network comprising a base station 400 and three radio nodes 451, 452, 453 is shown.

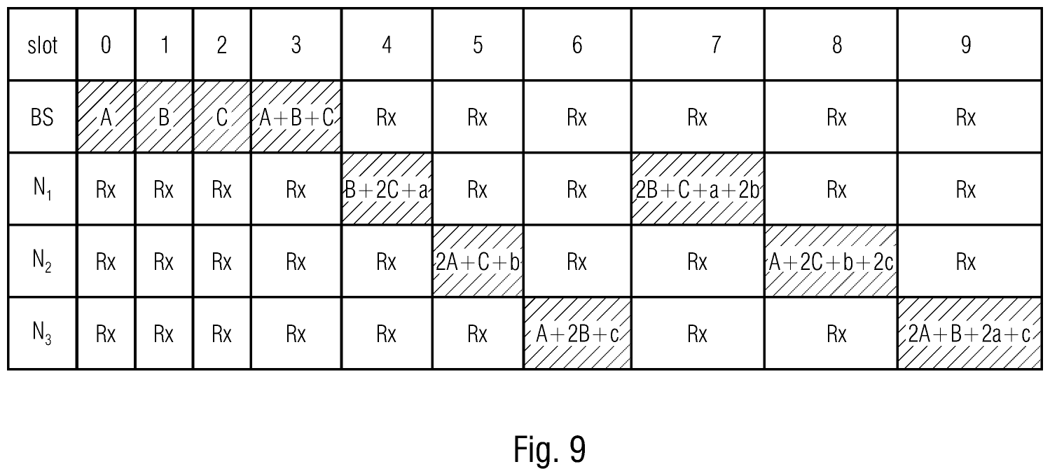

FIG. 9 shows an example of a possible superframe structure having network-coded cooperation, wherein the network comprises a base station and three radio nodes.

A database (DB) is used for temporary storage of the data of the link analysis. Each entry in the database contains the superframe number, the transmitting node ID, the receiving node ID, and the status of the packet reception (0—successful or 1—transmission error). These values can be combined as data tuples {superframe no., transmitting node ID, receiving node ID, status of the packet reception} For example, the successful packet transmission in superframe 12 on the connection from node N₁ to node N₂ is described by the data tuple {12, N₁, N₂, 0}.

In order to simplify the explanation of the embodiment, the following notations are used.

Rxᵢ^{N}^{ₓ}^{,N}^{_{y}}=True

describes the case where the radio node Nₓ could correctly receive the packet from N_{y} in slot i. In an equivalent manner,

Rxᵢ^{N}^{ₓ}^{,N}^{_{y}}=False

describes the case where the radio node Nₓ could not correctly receive the packet from N_{y} in slot i.

{A,B}⊆Pᵢ^{N}^{_{y}}

describes that, the packet sent out from the radio node N_{y} in slot i contains the messages “A” and “B”, encoded via NCC.

After termination of the superframe, the base station begins to evaluate the received packets and their content. By evaluating the packets received in slots 6-11, the base station can conclude the packet error rate on the various connections.

This is described in the following for the superframe k, the structure of which is shown in FIG. 9.

| | | Evaluation of the |
|---|---|---|
| Slot | Evaluation of the | contents of the received |
| ID | packet reception | packet |
| 4 | IF (Rx₄^{BS, N}^{₁} = True) | IF ({B, C} ⊆ P₄^{N}^{₁}) |
| | THEN | THEN |
| | DB entry | DB entry {k, BS, N₁, 0} |
| | {k, N₁, BS, 0} | ELSE |
| | ELSE | DB entry {k, BS, N₁, 1} |
| | DB entry | |
| | {k, N₁, BS, 1} | |
| 5 | equivalent to slot 4 | equivalent to slot 4 |
| 6 | equivalent to slot 4 | equivalent to slot 4 |
| 7 | IF (Rx₇^{BS, N}^{₁} = True) | IF ({b} ⊆ P₇^{N}^{₁}) |
| | THEN | THEN |
| | DB entry | DB entry {k, N₂, N₁, 0} |
| | {k, N₁, BS, 0} | ELSE |
| | ELSE | IF ({B, C} ⊆ P₇^{N}^{₁}) |
| | DB entry | THEN |
| | {k, N₁, BS, 1} | DB entry {k, N₂, N₁, 1} |
| 8 | equivalent to slot | equivalent to slot 7, |
| | 7 | i.e. |
| | | IF ({c} ⊆ P₈^{N}^{₂} |
| | | THEN |
| | | DB entry {k, N₃, N₂, 0} |
| | | ELSE |
| | | IF ({A, C} ⊆ P₅^{N}^{₂}) OR |
| | | ({A, C} ⊆ P₈^{N}^{₂}) |
| | | THEN |
| | | DB entry {k, N₃, N₂, 1} |
| 9 | equivalent to slot | equivalent to slot 7, |
| | 7 | i.e. |
| | | IF ({a} ⊆ P₉^{N}^{₃}) |
| | | THEN |
| | | DB entry {k, N₁, N₃, 0} |
| | | ELSE |
| | | IF ({A, B} ⊆ P₆^{N}^{₃}) OR |
| | | ({A, B} ⊆ P₉^{N}^{₃}) |
| | | THEN |
| | | DB entry {k, N₁, N₃, 1} |

The average packet error rate of a connection at a particular timepoint can be calculated b filtering the database of the link analysis for individual connections, and using a sliding time window. This step can be carried out for all the connections listed in the database, giving a complete overview of the connection quality in the network. This information can inter alia be provided to the network management, or used in another manner.

A second detailed embodiment is provided in the following.

Building on the scenario in the first detailed embodiment, in this embodiment additional information relating to the quality of the side links is intended to be transmitted to the base station. Here, too, the network topology shown in FIG. 8, comprising a base station and three radio nodes, as well as the code matrix described in FIG. 9, is intended to be used.

In order to determine the quality of the connections, the SNR of the side links is intended to be gathered, quantized, transmitted to the base station, and enter into the link analysis there.

As in embodiment 1, a database (DB) is intended to be used for temporary storage of the data of the link analysis. Here, too, each entry in the database contains the superframe number, the transmitting node ID, the receiving node ID, and the status of the packet reception (0—successful or 1—transmission error). In addition, the signal-to-noise ratio quantized with the two-bit resolution is also stored. In this case, the following association between the quantized value and the signal-to-noise ratio is used:

| Quantizing value | Signal-to-noise ratio (SNR) |
|---|---|
| 0b00 (0) | <10 dB |
| 0b01 (1) | 10 dB-20 dB |
| 0b10 (2) | 20 dB-30 dB |
| 0b11 (3) | >30 dB |

These values can be combined as data tuples {superframe no., transmitting node ID, receiving node ID, status of the packet reception, SNR}. For example, the successful packet transmission having an SNR between 20 dB and 30 dB in superframe 12 in slot 6 on the connection from node N₁ to node N₂ is described by the data tuple {12, N₁, N₂, 0, 0b10}.

By way of example, the radio node N₂ is considered an example of the communication process. It receives packets from the base station in slots 0, 1, 2 and 3. This is not yet a side link. However, the radio node N₁ transmits in slot 4. The radio node N₂ receives the transmitted message, and in the process measures the signal-to-noise ratio SNR. The measured SNR is quantized in the radio node N₂ and stored as SNR_{q}.

In slot 5, the radio node N₂ has a transmission slot and is intended to send the superposition “2A”+“C”+“b”. In order to code the quantized SNR into the packet to be sent, the radio node rotates the subpacket “b” corresponding to the value of SNR_{q}, to the right by 0, 1, 2 or 3 bits. The sent superposition is thus called “2A”+“C”+rot(“b”, SNR_{q}).

The base station and the radio nodes N₁ and N₃ receive the rotated message. The decoding method in the base station will now be described by way of example.

However, this does not constitute a restriction. The nodes N₁ and N₃ can in turn also carry out the decoding method described in the following.

The base station receives the sent packet superposition “2A”+“C”+rot(“b”, SNR_{q}) and attempts to decode it. The sub-messages “A” and “C” are known because they were sent by the base itself. The sub-message rot(“b”, SNR_{q}) can be extracted by subtraction.

The rotated sub-message is now rotated in parallel in the base, to the left by 0, 1, 2 and 3 bits, and each of these rotations is checked for integrity. In this case, the error protection code CRC-16 is used. The check will be successful only if the message was rotated to the left by SNR_{q} during decoding. In this way, the base station learns the quantized signal-to-noise ratio of the side link between the nodes N₁ and N₂ and can store it in the link analysis database. These steps are carried out analogously for all further nodes and side links.

An advantage of embodiments is that of network analysis without signaling effort. By means of the concepts provided, the network management receives current information, at any time and without delay, relating to the state of the connections in the network, without requiring additional transmission resources (bit fields in packets to be transmitted, or additional packets) for this purpose. That is to say that there are no restrictions in the amount of transmittable payload, and/or the necessary transmission duration does not have to be extended.

A further advantage is the increased reliability: Since the network management knows the current state of connections in the network at any time, it can use this knowledge for optimum adaptation of the coding regulation of the network coding used, and/or the resource allocation to the individual connections, to the current state of the connections in the network. Thus, as a result, the transmission reliability on the connections can be significantly increased.

Furthermore, an advantage is that of more efficient use of the radio transmission resources: Since the network management knows the current state of connections in the network at any time, it can use this knowledge for optimizing the resource scheduling, i.e. each connection is allocated only as many resources as are actually used.

A further advantage is that of reducing the transmission latencies: Since the transmission resources can be optimally adapted to the state of the current connection, the need for packet repetitions is reduced, and thus the end-to-end transmission latency is reduced.

Furthermore, an advantage is the suitability for radio systems having very high real-time and reliability demands: Due to the above-described technical properties and the advantages emerging from this, the proposed method is suitable in particular for radio systems which are subject to very high demands with respect to their real-time capability (i.e. extremely short, guaranteed transmission latencies) and reliability (i.e. extremely low likelihood of transmission errors).

In embodiments, a structure of the transmitted radio packets comprises only a packet header and a payload, encoded by means of network-coded cooperation. The radio packets do not contain any separate bitfields for transmitting the connection quality. For example, a network manager can nonetheless have information relating to side links in the network in which the base station (or the relevant radio nodes to which the network manager is linked) is not actively involved. This information is used, for example, of specifying/adapting the coding matrix or for outputting to users (visualization) or to other technical systems (e.g. a superordinate management or the management of an adjacent communication system).

In embodiments, the structure of the packets having NCC-encoded payload is modified depending on the connection quality between the radio nodes.

A technical field of application of the present invention is a radio system which has to meet very high requirements with respect to its high transmission reliability, and for this cooperation methods are used, such as from the field of cooperative relaying or network coded cooperation.

Although some aspects have been described in connection with an apparatus, it is clear that these aspects also constitute a description of the corresponding method, and therefore a block or a component of an apparatus is also be understood as a corresponding method step or as a feature of a method step. Analogously thereto, aspects which have been described in connection with or as a method step also constitute a description of a corresponding block or detail or feature of a corresponding apparatus. Some or all of the method steps can be carried out by a hardware apparatus (or using a hardware apparatus), such as a microprocessor, a programmable computer, or an electronic circuit. In some embodiments, some or more of the most important method steps can be performed by an apparatus of this kind.

Depending on specific implementation requirements, embodiments of the invention can be implemented in hardware or in software, or at least in part in hardware or at least in part in software. The implementation can be carried out using a digital storage medium, for example a floppy disk, a DVD, a Blu-ray disk, a CD, a ROM, a PROM, an EPROM, an EEPROM, or a FLASH memory, a hard disk, or another magnetic or optical memory, on which electronically readable control signals are stored, which can interact or interact with a programmable computer system in such a way that the respective method is carried out. Therefore, the digital storage medium can be computer-readable.

Some embodiments according to the invention thus comprise a data medium which comprises electronically readable control signals which are capable of interacting with a programmable computer system in such a way that one of the methods described herein is carried out.

In general, embodiments of the present invention can be implemented as computer program products comprising a program code, wherein the program code is effective so as to carry out one of the methods when the computer program product runs on the computer.

The program code can also be stored, for example, on a machine-readable carrier.

Other embodiments include the computer program for carrying out one of the methods described herein, wherein the computer program is stored on a machine-readable carrier. In other words, one embodiment of the method according to the invention is therefore a computer program which comprises a program code for carrying out one of the methods described herein when the computer program runs on a computer.

A further embodiment of the method according to the invention is therefore a data medium (or a digital storage medium or a computer-readable medium) on which the computer program for carrying out one of the methods described herein is recorded. The data medium or the digital storage medium or the computer-readable medium are typically tangible and/or non-volatile.

A further embodiment of the method according to the invention is therefore a data stream or a sequence of signals which represent(s) the computer program for carrying out one of the methods described herein. The data stream or the sequence of signals can, for example, be configured so as to be transferred via a data communication link, for example via the Internet.

A further embodiment comprises a processing device, for example a computer or a programmable logic component which is configured or adapted to carry out one of the methods described herein.

A further embodiment comprises a computer on which the computer program for carrying out one of the methods described herein is installed.

A further embodiment according to the invention comprises an apparatus or a system which is configured to transfer a computer program, for carrying out at least one of the methods described herein, to a receiver. The transmission can take place electronically or optically, for example. The receiver can, for example, be a computer, a mobile device, a memory device, or a similar device. The apparatus or the system can, for example, comprise a file server for transmitting the computer program to the receiver.

In some embodiments, a programmable logic component (for example a field-programmable gate array (FPGA)) can be used to carry out some or all of the functionalities of the methods described herein. In some embodiments, a field-programmable gate array can interact with a microprocessor in order to carry out one of the methods described herein. In general, in some embodiments the methods are carried out using any hardware device. This can be universally implementable hardware such as a computer processor (CPU) or hardware specific to the method, such as an ASIC.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. An apparatus for determining a transmission quality in a communications network,
wherein a first network unit of the communications network is configured to perform a first data transmission, in that first data, to be sent from the first network unit, are transmitted in such a way that a first data packet depends on the first data,
wherein a second network unit of the communications network is configured to perform a second data transmission, in that second data, to be sent from the second network unit, are transmitted in such a way that the second data are combined with the first data in a second data packet,
wherein the apparatus comprises a receiving unit configured to receive the second data transmission, and
wherein the apparatus comprises an evaluation unit configured to determine a first quality of the first data transmission and/or a second quality of the second data transmission, in that the evaluation unit evaluates the second data packet.

2. The apparatus according to claim 1,
wherein the evaluation unit is configured to determine whether the first data transmission from the first network unit to the second network unit has taken place successfully, in that the evaluation unit evaluates a header of the second data packet.

3. The apparatus according to claim 2,
wherein the evaluation unit is configured to evaluate the header of the second data packet as to whether the header of the second data packet comprises coding information for decoding the first data of the second data packet.

4. The apparatus according to claim 2,
wherein the evaluation unit is configured to evaluate the header of the second data packet as to whether the header of the second data packet comprises a coding coefficient which the second network unit has used for coding the first data in the second data packet.

5. The apparatus according to claim 1,
wherein the receiving unit is configured to receive the first data transmission and the second data transmission,
wherein the evaluation unit is configured to determine a first quality of the first data transmission and/or a second quality of the second data transmission, in that the evaluation unit evaluates the first data packet and the second data packet.

6. The apparatus according to claim 5,
wherein the evaluation unit of the apparatus is configured to determine the first data from the first data packet as first identified data, and
wherein the evaluation unit of the apparatus is configured to determine, using the first identified data, whether the second data packet was formed using the first data,
wherein the evaluation unit of the apparatus is configured to determine that the first data transmission from the first network unit to the second network unit has taken place successfully when the second data packet was formed using the first data, and
wherein the evaluation unit of the apparatus is configured to determine that the first data transmission from the first network unit to the second network unit has not taken place successfully when the second data packet was not formed using the first data.

7. The apparatus according to claim 1,
wherein a third network unit of the communications network is configured to perform a third data transmission, in that third data, to be sent from the third network unit, are transmitted in such a way that the third data are combined with the first data and with the second data in a third data packet,
wherein the evaluation unit of the apparatus is configured to determine the first data from the first data packet as first identified data, and
wherein the evaluation unit of the apparatus is configured to determine the second data from the second data packet as second identified data, and
wherein the evaluation unit of the apparatus is configured to determine, using the first identified data and using the second identified data, whether the third data packet was formed using the first data and using the second data,
wherein the evaluation unit of the apparatus is configured to determine that the first data transmission from the first network unit to the third network unit has taken place successfully, and that the second data transmission from the second network unit to the third network unit has taken place successfully when the third data packet was formed using the first data and using the second data, and
wherein the evaluation unit of the apparatus is configured to determine that the first data transmission from the first network unit to the third network unit and/or the second data transmission from the second network unit to the third network unit has not taken place successfully when the third data packet was not formed using both the first data and the second data.

8. The apparatus according to claim 1,
wherein the apparatus comprises a sending unit configured to perform a first further data transmission, in that first further data, to be sent from the sending unit, are transmitted in such a way that the first further data are combined with the first data and with the second data in a first further data packet,
wherein the first network unit or the second network unit or a further network unit of the communications network is configured to perform a second further data transmission, in that second further data, to be sent, are transmitted in such a way that the second further data are combined with the first further data in a second further data packet,
wherein the receiving unit of the apparatus is configured to receive the second further data transmission,
wherein the evaluation unit of the apparatus is configured to determine, using the first further data, whether the second further data packet was formed using the first further data,
wherein the evaluation unit of the apparatus is configured to determine that the first further data transmission from the apparatus to the first network unit or to the second network unit or to the further network unit has taken place successfully when the second further data packet was formed using the first further data, and
wherein the evaluation unit of the apparatus is configured to determine that the first further data transmission from the apparatus to the first network unit or to the second network unit or to the further network unit has not taken place successfully when the second further data packet was not formed using the first further data.

9. The apparatus according to claim 1,
wherein the apparatus is configured to keep link statistics for each pair of one transmitting network unit and one receiving network unit from a group of network units of the communications network comprising the first network unit and the second network unit, which statistics record each successful data transmission, identified by the apparatus, from the transmitting network unit to the receiving network unit, as successful data transmission, and/or record each unsuccessful data transmission, identified by the apparatus, from the transmitting network unit to the receiving network unit, as unsuccessful data transmission.

10. The apparatus according to claim 1,
wherein the second network unit is configured to determine information relating to a data transmission quality from the first network unit to the second network unit,
wherein the second network unit is configured to transmit the information, relating to the data transmission quality from the first network unit to the second network unit, to the apparatus, in that the second network unit selects a coding rule from a group of two or more coding rules, and codes the first data and/or second data and/or a combination of the first data and the second data in the second data packet depending on the coding rule, and provides them with a check code, and
wherein the apparatus is configured to identify the information relating to the data transmission quality from the first network unit to the second network unit in that the apparatus determines, using the check code comprised in the second data packet, the coding rule of the two or more coding rules that was selected by the second network unit.

11. The apparatus according to claim 1,
wherein the second network unit is configured to perform the second data transmission, in that the second data, to be sent from the second network unit, are transmitted in such a way that the second data are combined with the first data, as the second data packet, by superposition.

12. The apparatus according to claim 1,
wherein the second network unit is configured to perform the second data transmission, in that the second data, to be sent from the second network unit, are transmitted in such a way that the second data are XOR-linked with the first data in the second data packet, or that the second data are combined with the first data by means of a weighted addition, or that the second data are combined with the first data by a superposition in a Galois field.

13. The apparatus according to claim 1,
wherein the second network unit is configured to combine the first data, which are combined using a first coding coefficient, with the second data, which are combined using a second coding coefficient, in the second data packet.

14. The apparatus according to claim 13,
wherein the second network unit is configured to XOR-link the first data, which are multiplied by a first coding coefficient, with the second data, which are multiplied by a second coding coefficient, in the second data packet.

15. The apparatus according to claim 1,
wherein the communications network is a wireless communications network,
wherein the first network unit is a first wireless network unit,
wherein the second network unit is a second wireless network unit,
wherein the receiving unit of the apparatus is a receiving unit for receiving wireless data transmissions.

16. The apparatus according to claim 1, wherein apparatus is implemented as a base station of a wireless communications network.

17. A communications network, comprising:
a first network unit,
a second network unit, and
an apparatus according to claim 1 for determining a transmission quality in a communications network,
wherein the first network unit is configured to perform a first data transmission, in that first data, to be sent from the first network unit, are transmitted in such a way that a first data packet depends on the first data,
wherein a second network unit is configured to perform a second data transmission, in that second data, to be sent from the second network unit, are transmitted in such a way that the second data are combined with the first data in a second data packet,
wherein the receiving unit of the apparatus is configured to receive the second data transmission, and
wherein the evaluation unit of the apparatus is configured to determine the first quality of the first data transmission and/or the second quality of the second data transmission, in that the evaluation unit evaluates the second data packet.

18. The communications network according to claim 17,
wherein the communications network is a wireless communications network,
wherein the first network unit is a first wireless network unit,
wherein the second network unit is a second wireless network unit,
wherein the receiving unit of the apparatus is a receiving unit for receiving wireless data transmissions.

19. A method for determining a transmission quality in a communications network, the method comprising:
performing a first data transmission by a first network unit of the communications network, in that first data, to be sent from the first network unit, are transmitted in such a way that a first data packet depends on the first data,
performing a second data transmission by a second network unit of the communications network, in that second data, to be sent from the second network unit, are transmitted in such a way that the second data are combined with the first data in a second data packet,
receiving the second data transmission by a receiving unit of an apparatus, and
determining a first quality of the first data transmission and/or a second quality of the second data transmission by an evaluation unit of the apparatus, in that the evaluation unit evaluates the second data packet.

20. A non-transitory computer-readable medium comprising a computer program for implementing the method of claim 19, when the method of claim 19 is implemented by a computer or signal processor.
